(19) United States
(12) Patent Application Publication
(10) Pub. No.: US 2007/0137062 A1
(43) Pub. Date: Jun. 21, 2007

(54) Increased Negative Static Pressure Drying

(76) Inventor: Gary A. Eck, Fairfield, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/675,254

(22) Filed: Feb. 15, 2007

Related U.S. Application Data
(63) Continuation-in-part of application No. 11/174,340, filed on Jul. 5, 2005.

(51) Int. Cl. F26B 3/08

(52) U.S. Cl. 34/360

(57) ABSTRACT

The present invention relates to methods of drying comprising an intentionally controlled increased negative static pressure level and drying systems using the same.

### CROSS-REFERENCE TO RELATED APPLICATION

The present invention is a continuation-in-part of U.S. patent application Ser. No. 11/174,340, filed Jul. 5, 2005.

### FIELD OF INVENTION

The present invention relates to methods drying comprising a controlled increased negative static pressure level and drying systems using the same.

### BACKGROUND OF THE INVENTION

Drying of materials in the production of a final product is one process of product manufacturing in many industries, including, without limitation, the pharmaceutical and biotechnology industries, consumer products industry, food industry, chemical industry and fuel industry. The material to be dried can be powders, granules, agglomerates, pellets, or a combination thereof. The material can inherently contain moisture for which removal is desirable. Or the material can be wetted during manufacturing in order to achieve the desirable final product. When the material is wetted it can be wetted, for example, by a wet massing step (e.g., adding an amount of liquid in relation to time to a material, which often is a powder), wet milling step (e.g., the grinding of materials with sufficient liquid to form a slurry), wet sizing step (e.g., screening or sieving wetted material) or combination thereof. Those skilled in the art will be familiar with the various means of wetting a material, if necessary, as well as suitable solvents that can be used (e.g., aqueous, non-aqueous, nonflammable, flammable, aprotic, protogenic, and the like).

Various dryer units can be used in drying systems utilized in drying materials. Some examples of such dryers are, without limitation, ploughshare, conical, indirect, desiccant, fluid bed, blender, helix, mixer, turbo, air, paddle, belt, filter press, cone screw mixer, tri-shaft, and variants thereof.

Some negative static pressure (not vacuum pressure) is inherent within the drying system due to the resistance to gas flow by additional components in the gas stream, such as, but not limited to, filters, heating coils, cooling coils, ductwork, louvers, air handling equipment and accessories, fans, dehumidification equipment, and humidification equipment, and any combination thereof. Good engineering practice, e.g., best practices of engineering, however, minimizes the level of negative static pressure caused by additional components comprising a drying system. Negative static pressure, therefore, is unrecognized and not intentionally controlled in drying processes.

The properties of a given material can be determined from drying data, such as the change in volatile content over time in a batch fluid bed operating under controlled conditions. Negative static pressure intentionally controlled during the drying process, therefore, can be useful in determining properties and drying rates of a given material. Other properties of a given material that may be determined from drying data for the material include, but without limitations, equilibrium volatile content, boiling point and flash point. Thus, negative static pressure also can be useful for materials with properties that could be detrimental at atmospheric conditions or close to atmospheric conditions, such as flash point.

It now has been found that intentionally controlling negative static pressure to levels above those levels that are inherent in a well engineered drying system (i.e., one meeting best practices of engineering) results in decreased drying times, and thus, improved drying efficiency.

### BRIEF SUMMARY OF THE INVENTION

The present invention provides a process for drying a material comprising an intentionally controlled increased level of negative static pressure as compared to that which the process would inherently have when the negative static pressure is not intentionally controlled.

In some embodiments, the intentionally controlled increased level of negative static pressure of the process of the present invention substantially increases removal of liquid from the material. In some such embodiments, the substantially increased removal of liquid from the material results in a substantially reduced drying time for the material.

In some embodiments, the process of the present invention further comprises a drying system that comprises at least one drying unit. In some such embodiments, at least one drying unit is selected from the group consisting of a ploughshare dryer, conical dryer, indirect dryer, desiccant dryer, fluid bed dryer, blender dryer, helix dryer, mixer dryer, turbo dryer, air dryer, paddle dryer, belt dryer, filter press dryer, cone screw mixer dryer, and tri-shaft dryer.

In some embodiments, the process of the present invention has an increased level of negative static pressure that is less than about 124 inches of water column (527 mmHg). In some embodiments, the increased level of negative static pressure of the process of the present invention is greater than that for atmospheric fluid bed drying. In some embodiments, the increased level of negative static pressure is imparted in an area of the fluid bed dryer for drying the material.

In some embodiments, the material of the process of the present invention comprises a powder, a granulation, an agglomeration, pellets, or a mixture thereof. In some embodiments, the material of the process inherently is wet. In some embodiments, the process of the present also comprises wetting the material.

The present invention further provides a drying system comprising:

a) a preconditioning unit, which comprises a set of accessories including:
(i) at least one pre-filter; and
(ii) at least one bag filter;
wherein the set of accessories are in fluid communication with each other;

b) a negative static pressure control unit comprising:
(i) a static pressure control damper;
(ii) a static pressure sensor; and
(iii) a controller;
wherein the static pressure control damper, static pressure sensor and controller are in fluid communication with each other, and the negative static pressure control unit is in fluid communication with the preconditioning unit;

c) a dryer unit; and

d) an exhaust fan,

where the dryer unit is in fluid communication with the negative static pressure control unit and the exhaust fan.

In some embodiments, the set of accessories of the preconditioning unit of the drying system of the present invention further comprises at least one face-and-bypass damper. In some embodiments, the set of accessories further comprises at least one humidifier, at least one dehumidifier, or both. In some embodiments, the set of accessories further comprises at least one cooling coil. In some embodiments, the set of accessories further comprises at least one preheating coil, at least one freezing protection coil, or both.

In some embodiments, the drying system of the present invention further comprises at least one final heating coil, at least one HEPA filter, at least one conditioning unit, at least one bypass damper, at least one vent cap, or a combination thereof.

In some embodiments, the dryer unit of the drying system of the present invention comprises at least one fluid bed dryer.

In some embodiments, the exhaust fan of the drying system of the present invention comprises a motor having an inverter disposed thereon, wherein the motor is in fluid communication with the exhaust fan. In some embodiments, the exhaust fan of the drying system of the present invention comprises variable inlet vanes disposed on an inlet of the exhaust fan.

The present invention further provides a drying system for removing liquid from a material, comprising:

a) a preconditioning unit;

b) a negative static pressure control unit in fluid communication with the preconditioning unit;

c) a dryer unit, and

d) an exhaust fan;

where the dryer unit is in fluid communication with the negative static pressure control unit and the exhaust fan; and

where the negative static pressure control unit controls negative static pressure applied to the material so that as the negative static pressure increases in the system, the rate of liquid removed from the material increases.

In some embodiments, the material of the drying system of the present invention is dried at a substantially reduced drying time.

In some embodiments, a drying system of the present invention operates under a process of the present invention.

### BRIEF DESCRIPTION OF THE DRAWINGS

FIG. 1: A schematic of a drying system for use in one embodiment of the process of the present invention.

FIG. 2: A schematic of a drying system for use in another embodiment of the process of the present invention.

### DETAILED DESCRIPTION OF THE INVENTION

It is intended that all terms and phrases used in the present application include the plural, active tense and past tense forms of a term and a phrase.

The present invention provides a process for drying a material comprising a intentionally controlled increased level of negative static pressure as compared to that which the process would inherently have when the negative static pressure is not intentionally controlled. There is a distinct difference between “negative static pressure” and “vacuum”. See also, e.g., Baumeister & Marks (eds.), Standard Handbook for Mechanical Engineers, 7^{th} ed. McGraw-Hill: New York (1967), Table 22, pp. 4-15. The phrase “static pressure” refers to the pressure of a fluid exerted in all directions equal and opposite to the pressure tending to compress the fluid. In ventilation applications, static pressure is often the difference between the absolute pressure in an exhaust system and atmospheric pressure, such that static pressure less than atmospheric pressure is termed “negative static pressure” and static pressure above atmospheric pressure is termed “positive static pressure.” The phrase “static pressure” can be used to specify a nominal pressure in a system, often acting as the reference pressure for differential pressure measurements; and also it can refer to the condition where pressure values are stable, which is desirable when making non-dynamic pressure measurement (e.g., a pressure whose value changes insignificantly, if at all, a short period of time). See, National Physical Laboratory. Frequently asked questions—pressure and vacuum: Glossary of terms used in pressure and vacuum metrology. National Physical Laboratory: Middlesex, UK, available at www.npl.co.uk/pressure/faqs/glossary.html (last visited, Jan. 20, 2007).

The term “vacuum” simply refers to part of the pressure scale. Though its definition is not precise, it is commonly taken to mean pressures below, and often considerably below, atmospheric pressure. What is particularly important, however, is to appreciate that “a vacuum” refers to a pressure measured with respect to zero pressure (i.e., an absolute pressure) and not with respect to ambient pressure or some other pressure. (As used herein, the term “vacuum” and the phrase “vacuum pressure” are synonymous.) Thus, vacuum is pressure and more particularly, it is a special case of static pressure. However, even though vacuum is a special case of static pressure, the range of vacuum pressure is typically significantly lower and has different units of measure than that of static pressure referred to as “negative static pressure.” Vacuum is often measured in units of torr, though it is also often measured using micrometers of mercury (mm Hg), the barometric scale, or as a percentage of atmospheric pressure in bars or atmospheres. However, low vacuum often is measured in inches of mercury (inHg). Yet, negative static pressure often is measured in inches of water or water column (WC), or millimeters of water (mmH₂O). Additionally, as the amount or degree of vacuum approaches perfect vacuum the units of measure in mmHg become smaller. Conversely, as the as the amount of negative static pressure moves in the direction of perfect vacuum the units of measure in negative inches of water column become larger. “Perfect vacuum” refers to the absence of gas or liquid molecules in a volume of space or alternatively, a volume of space that is essentially empty of matter.

Vacuum quality is subdivided into ranges according to the technology required to achieve it or measure it. These ranges do not have universally agreed definitions (hence the gaps below), but a typical distribution is as shown in Table 1 compared to atmospheric pressure.

TABLE 1
Vacuum Quality Ranges*

| Quality Range of | Pressure Range | |
|---|---|---|
| a Vacuum | Torr | Pascal |
| Atmospheric pressure | 760 | 101 × 10³ |
| Low vacuum | 760 to 25 | 100 × 10³ to 3 × 10³ |
| Medium vacuum | 25 to 1 × 10⁻³ | 3 × 10³ to 1 × 10⁻¹ |
| High vacuum | 1 × 10⁻³ to 1 × 10⁻⁹ | 1 × 10⁻¹ to × 10⁻⁶ |
| Ultra high vacuum | 1 × 10⁻⁹ to 1 × 10⁻¹² | 1 × 10⁻⁷ to 1 × 10⁻¹⁰ |
| Extremely high vacuum | <1 × 10⁻¹² | <1 × 10⁻¹⁰ |
| Perfect vacuum | 0 Torr | 0 Pa |

*American Vacuum Society. AVS ® Technical Resources: GlossaryReference Guide. AVS ®: New York, available at www.avsbuyersguide.org/refguide/glossary.html (last visited, 20 Jan. 2007); National Physical Laboratory. Frequently asked questions - pressure and vacuum. National Physical Laboratory: Middlesex, UK, available at www.npl.co.uk/pressure/faqs/vacuum.html (last visited, 20 Jan. 2007).

In some embodiments, the process of the present invention also comprises a drying system that comprises a drying unit. Suitable dryer units for the process of the present invention include, without limitation: (1) a ploughshare dryer, which comprises a ribbon type blender-dryer often having one or more paddies that plow through the material to be dried, (2) a conical dryer, such as one comprising either a conical or double conical shell or vessel, which often is rotating, (3) an indirect dryer, such as one comprising a vessel with heated walls, (4) a desiccant dryer, e.g., wherein the material to be dried is subjected to gas that has been dried by prior exposure to a desiccant, (4) a fluid bed dryer, either a batch or continuous type, optionally vibrating, such dryer often is fluidized with gas flowing up through a bed containing the material to be dried, (5) a blender dryer of any type of blender, i.e., rotating, ribbon, or the like, (6) a helix dryer, such as one comprising a conical vessel wherein a circulating helical screw moves through the material to be dried, (7) a mixer dryer, such as one comprising a rotating vessel, (8) a turbo dryer, which is similar to the mixer dryer, (9) an air dryer, wherein air is blown at the material to be dried, (10) a paddle dryer, which is similar to a ploughshare dryer, (11) a belt dryer, wherein the material to be dried moves along on a belt while being subjected to heat, gas flow, or both, (12) a filter press dryer, wherein the material to be dried is pressed between fine filters thus separating the material from any liquid, (13) a cone screw mixer dryer, which is similar to a helix dryer, and (14) a tri-shaft dryer, which comprises a number of shafts, e.g., three (3) that circulate the material to be dried during the drying process. In some embodiments, the drying system of the process of the present invention comprises more than one dryer unit. In some embodiments, more than one dryer units is the same type of dryer unit; in some embodiments, they are a combination of different dryers.

Suitable dryer units for the process of the present invention can be obtained from a number of dryer manufactures throughout the United States, who often can provide several types of suitable dryers. Some dryer manufacturers who can provide the aforementioned suitable dryers include, for example, KMPT USA Inc., Florence, Ky., Charles Ross & Son Company, Hauppauge, N.Y., Kason Corporation, Milburn, N.J., Glatt Air Techniques Inc., Ramsey, N.J., General Kinematics Corporation, Crystal Lake, Ill., Carrier® Vibrating Equipment, Inc., Louisville, Ky., Fluid Air Inc., Aurora, Ill., Dynamic Air Inc., St. Paul, Minn., Niro Inc., Columbia, Md., Heinkel® USA, Swedesboro, N.J., Ventilex® USA Inc., West Chester, Ohio, Sterling, New Berlin, Wis., Komline-Sanderson Engineering Company, Peapack, N.J., Wyssmont Company, Inc., Fort Lee, N.J., Bolz-Summix, a division of the MPE Group, Swedesboro, N.J., Applied Chemical Technology Inc., Florence, Ala., Evaporator Dryer Technologies, Inc., Hammond, Wis., Siemens Water Technology (formerly USFilter Dewatering Systems), Holland, Mich., Scott Equipment Company, New Prague, Minn., Heinen Drying, Inc., Bristol, Pa., L.B. Bohle, LLC, Warminster, Pa., Pfaudler, Inc., Rochester, N.Y., Bepex International LLC, Minneapolis, Minn., Littleford Day, Inc., Florence, Ky., and Alstom Power, Inc., Warrenville, Ill.

In some embodiments, a drying unit of the process of the present invention is a fluid bed dryer. Fluid bed dryers are utilized for drying wetted materials by a process known in the art as fluid bed drying. Fluid bed drying often is used in pharmaceutical processing.

In fluid bed drying, uniform processing conditions are achieved by inducing or pulling a gas (e.g., air) through a layer of material under controlled velocity conditions, thereby creating a fluidized state of the material. The layer of material can be referred to as, for example, a product bed. Product bed further refers to the material at-rest with no airflow. The product bed can be a layer of material comprising the final product being manufactured or an intermediate product to be used in further in the manufacture of the final product. In pharmaceutical processing, a product bed often is referred to as a granulation because the active ingredient and excipients (i.e., non-active ingredients), each of which are initially distinct powders comprising particules, have been combined to result in granules or granular aggregates that comprise both active ingredient and excipients. See e.g., Lachman et al. The Theory and Practice of Industrial Pharmacy, 3rd ed. Stipes Publishing: Champaign, Ill. (1986).

In a fluid bed drying system, the gas for fluidizing and drying often is drawn from outside the building and through pre-filters and other equipment in the gas stream, such as a preheating coil, freeze protection coil or both, dehumidifier, humidifier, heater, temperature control device, HEPA (high efficiency particulate air) filter or combination thereof. Thus, often, the fluidizing and drying gas is air. Then, exiting the product bed of the drying system, the moisture laden gas passes through some type of product filter, air filter, or both, a main exhausting fan, and optionally, a final filter before being exhausted to the atmosphere. If the processing, involves organic solvents, abatement systems also may be incorporated into the drying system. During the drying process, heat is supplied to the fluidizing gas by a heating device, such as a heating coil. Heat to the gas flow also can be supplied by a surface that transmits heat (i.e., a heating surface or heater surface, such as a dimpled heated jacket within the fluid bed area). The fluid bed area refers to the entire area within the vessel where the product is maintained in a fluidized state.

Fluid bed drying is suited for material to be dried comprising, for example, and without limitation, powders, granules, agglomerates, pellets, and mixtures thereof. Some variations of the types of fluid bed drying are, for example, and without limitation, batch, continuous flow, vibratory, and double-dual deck.

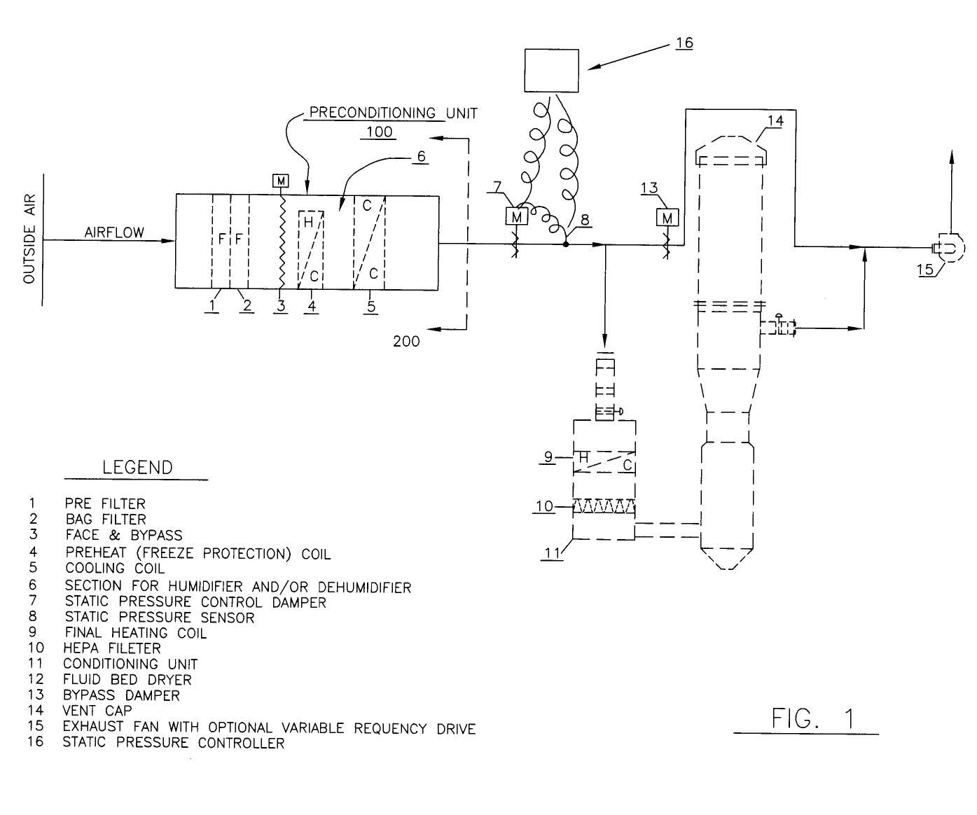

In some embodiments, the process of the present invention comprises a drying system having a fluid bed dryer, wherein the components of the system can be arranged as shown in FIG. 1. The drying system comprises a preconditioning unit (100) (see FIG. 1). The preconditioning unit (100) comprises accessory components, such as, but not limited to, at least one pre-filter (1), at least one bag filter (2), optionally, at least one face-and-bypass damper (3), optionally, at least one humidifier, at least one dehumidifier or both (6), optionally, at least one cooling coil (5) and optionally, at least one preheating coil (4a), at least one freezing protection coil (4b) or both (4), or a combination thereof (i.e., any combination of (1) to (6)). The arrangement of all the accessory components should be properly designed (i.e., should meet engineering best practices) to precondition the incoming gas so as to meet the discharge conditions of the preconditioning unit.

In some embodiments, the preconditioning unit (100) of a drying system of the present invention comprises at least one humidifier, at least one dehumidifier or both. In some embodiments, the preconditioning unit of a drying system of the present invention comprises at least one cooling coil. In some such embodiments, at least one cooling coil of a drying system is utilized for dehumidification. In some such embodiments, the cooling coil used for dehumidification is positioned inside a preconditioning unit. In some such embodiments, the cooling coil used for dehumidification is positioned outside an intentionally increased negative static pressure region (200). In some such embodiments, such positioning of the cooling coil results in more effective and efficient moisture removal from the incoming gas stream than if such cooling coil was positioned otherwise. In some embodiments, the preconditioning unit of a drying system of the present invention comprises at least one preheating coil, at least one freezing protection coil, or both. In some embodiments, the preconditioning unit of a drying system of the present invention comprises a combination of any one or more accessories (1) to (6).

In some embodiments, the increased level of negative static pressure is imparted in an area of the fluid bed dryer for drying the material, such as, for example, a product bed.

In some embodiments (as shown in FIG. 1), the drying system of the process of the present invention further comprises a static pressure control damper (7). The static pressure control damper (7) and static pressure sensor (8) are associated along with a controller (16). A suitable controller (16) for use in the present invention would automatically adjust the control damper to attain the negative static pressure set point in the controller as verified with feedback from the sensor as to what is actually the negative static pressure. Example of a suitable controller is a Partlow MIC 2000 Series PID Controller (Danaher Industrial Controls, Elizabethtown, N.C.). The static pressure control damper (7), static pressure sensor (8), and controller (16) will allow the automatic control of additional negative static pressure to be imparted in the desired area of drying in the fluid bed dryer (12). By closing the static pressure control damper, the negative static pressure level can be increased. The controller determines the degree or amount of closure. The negative static pressure set point is determined by those skilled in the art; for example, by bench top and pilot plant research and development taking into consideration limiting negative effects, such as, excessive energy usage and system constraints, and maximum negative static pressure without detrimental effects, such as collapse.

In some embodiments, the negative static pressure level can be increased manually. In some such embodiments, the drying system comprises a static pressure control, which is not associated with a static pressure sensor and an appropriate controller. In some embodiments, the static pressure control damper (7) can be positioned upstream of the fluid bed dryer (12). Locating the static pressure control damper as close to the dryer as possible, however, will reduce the number of drying system components that need to be designed to withstand (e.g., avoid collapse) the increased level of negative static pressure.

In some embodiments, the drying system comprises at least one exhaust fan. The exhaust fan(s) (15) of FIG. 1 draws, pulls or induces the fluidizing gas through the system. The exhaust fan(s) should be designed to overcome all gas flow resistances in the system and to draw through the proper quantity of fluidizing gas. Intentionally increasing the level of negative static pressure in a system with the arrangement of FIG. 1 likely will require the exhaust fan to be analyzed for proper sizing, classification and horsepower requirements as determined by the fan manufacturer with the parameters provided by the designing engineer, end user (e.g., research and development staff, formulators, system operators), or both.

In some embodiments, the exhaust fan of the drying system comprises a motor rated for inverter duty, i.e., the motor has an inverter (e.g., a variable frequency drive). The inverter of the exhaust fan motor controls the motor speed and, therefore, the speed of the exhaust fan, which allows for control of gas flow and fan performance. Having the motor of an exhaust fan rated for inverter duty and controlled with a variable frequency drive (controller/inverter), a drying system can be flexible in handling, for example, varying conditions, various products being dried, or both; because of the numerous combinations of a multitude of granulations and solvents the possibility of case hardening due to faster drying should be considered. Additionally, it should be recognized that increasing the negative static pressure level in the fluid bed dryer likely will require increased horsepower for the exhaust fan. Thus, all components should be properly engineered to handle the increased negative static pressure level.

In some embodiments, the exhaust fan of the drying system comprises variable inlet vanes disposed on the inlet of the exhaust fan. The variable inlet vanes allow control of the gas flow and fan performance by providing swirl or limiting gas flow to a fan impeller.

In some embodiments, the drying system of the present invention further comprises at least one final heating coil, at least one HEPA filter, at least one conditioning unit, at least one bypass damper, at least one vent cap, or a combination thereof. A conditioning unit often further heats the gas (e.g., air) to a higher desired temperature and further filters the gas to HEPA standards.

In some embodiments of the present invention, the increased level of negative static pressure is less than about 124 inches of water column (527 mmHg). In some embodiments of the present invention, the increased level of negative static pressure is greater than that for atmospheric fluid bed drying.

The foregoing and FIG. 1 illustrates only the principal of fluid bed drying used with the present invention to provide an intentional and controlled increase in negative static pressure level in a fluid bed dryer, thereby decreasing drying times. One skilled in the art will recognize that various other equipment (component) arrangements can be conceived for intentionally increasing the negative static pressure level in the area of drying. For example, in some embodiments, a process to intentionally increase the negative static pressure level of a drying system could involve, but is not limited to, designing the gas stream components that are positioned upstream of the dryer to be smaller or with higher resistance to the gas flow than those designed with good engineering practice to reduce gas flow resistance (e.g., larger or less resistant components).

It must be noted that, as used herein and in the appended claims, the singular forms “a”, “and”, and “the” include plural references, unless the context clearly dictates otherwise. All publications mentioned herein are incorporated herein by reference to disclose and described the methods and/or materials in connection with which the publications are cited.

### EXAMPLE

The following example is put forth so as to provide those of ordinary skill in the art with a complete disclosure and description of the present invention, and is not intended to limit the scope of what the inventor regards as his invention nor is it intended to represent that the experiment below is the only experiment performed.

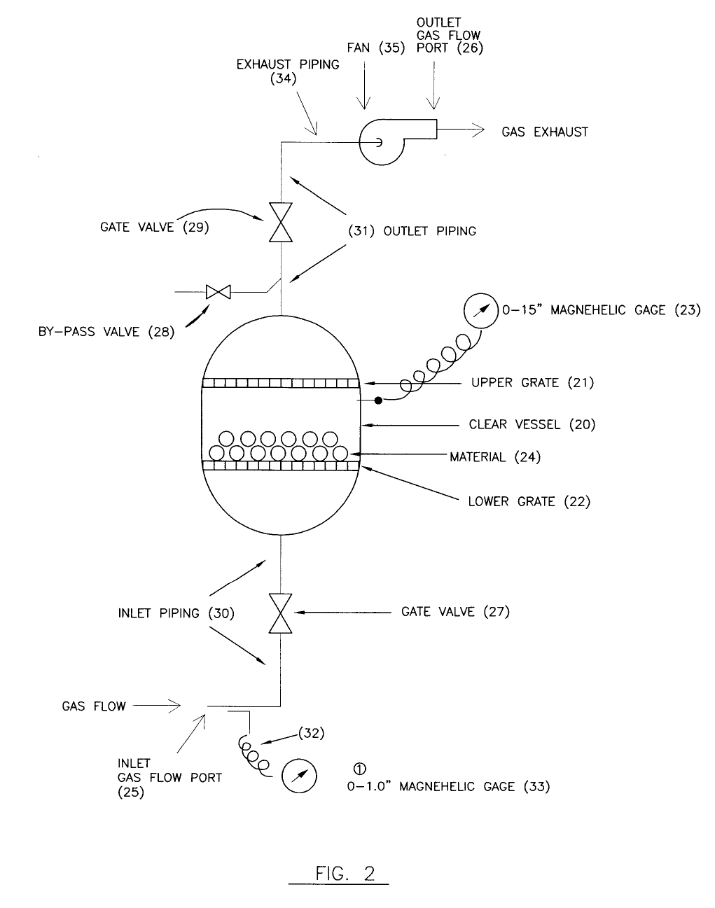

The following experiment was performed to determine the effect on drying of a wetted material by increasing the negative static pressure in the vessel in which the material was being dried (i.e., dryer bed). FIG. 2 illustrates the drying system used in the experiment. The gas used in the example was air and the solvent utilized was water.

Drying system. A clear vessel (20) in which the wetted material would be dried had a negative pressure measuring port connected to a Series 2000 Magnehelic®, model 2015, differential pressure gage (Dwyer Instruments Inc., Michigan City, Ind.) (23) to measure the negative pressure within the vessel (20). A lower grate (22) was installed inside the lower half of the vessel (20) to support and suspend the wetted material (24) in the vessel (20), The lower grate (22) also functioned as a diffuser allowing gas flow through the material (24) and vessel (20). An upper grate (21) was installed inside the upper half of the vessel (20) to prevent the possible exhausting of any of the material (24), thereby, acting as a trap. An inlet gas flow port (25) and outlet gas flow port (26) and piping were installed. Valves, Spears 1- 1/2 diameter, PVC, quarter turn ball valves, (27, 28, 29) were installed in the inlet piping (30) and (outlet piping (31) to (a) provide for uniform gas flow in all experimental rims, and (b) allow for regulating the negative static pressure within the vessel valve (27), a gate valve, allowed control of the negative static pressure of the system. Valve (28), a by-pass valve and valve (29), a gate valve, allowed control of gas flow to provide uniform gas flow for the two experimental runs. A pitot tube (32) connected to a Series 2000 Magnehelic®, model 2001, differential pressure gage (Dwyer Instruments, Inc., Michigan City, Ind.) (33) was installed in the gas flow inlet piping (30) to measure gas flow through the vessel (20) resulting in the same gas flow in each experimental run. A fan (35) from a wet/dry vacuum was utilized on the exhaust piping (34) to provide the airflow and negative static pressure. Random small pieces of sponge of various material and various configurations (average 1-2″ maximum dimensions) were utilized for the material (24) to be dried. (Although in pharmaceutical processing, granulations dried generally consist of smaller particle sizes (e.g., micoparticulate granulations) than those used herein, the particles are randomly shaped and sized as were the pieces of sponge used herein as the wetted material to be dried.) The solvent utilized for wetting the material was water. The gas used was air, which was drawn from outside the drying system. A Salter® model 6300 kitchen food scale (11 lb. capacity, 1/8 oz. accuracy) (Salter Housewares Ltd., Tonbridge, Kent, UK) was utilized for all weight measurements.

Testing parameters. All variables (e.g., time of run, beginning weight of solvent, airflow rate, temperatures, and amount of material) were held relatively constant. See e.g., Table 2. The only variable changed between each run was the internal static pressure. The static pressure in Run #1 was about minus 11.6 inches of water column (about −11.6″ WC). The static pressure of Run #2 was about minus 2 inches of water column (about −2″ WC). Run #1 was run at the greater negative static pressure level to provide for setting up and testing the equipment and accessories of the drying system.

TABLE 2
Testing Parameters for Experimental Runs

| Parameter | Run #1 | Run #2 |
|---|---|---|
| Temperature (° F.) | 64.2 | 68.8 |
| Relative Humidity (RH)(%) | 58.9 | 51.7 |
| Weights (oz.): | | |
| Container Tare | 6 | 6 |
| Material - Dry | 5 | 5 |
| Material - Wet | 22¾ | 22⅞ |
| Water load of material | 17¾ | 17⅞ |
| Enthalpy (BTU/lb. of dry air) | 23.5 | 25.0 |
| Grains of water | 53 | 55 |
| Maximum Enthalpy | | |
| (BTU/lb. of dry air) | | |
| @ 64.2 ° F., 90% RH | 28.2 | n/a¹ |
| @ 68.8 ° F., 90% RH | n/a¹ | 31.8 |
| Δ Enthalpy (BTU/lb. of dry air) | 4.7 | 6.8 |
| Velocity² (inches of WC on the | 0.495 | 0.495 |
| Magnehelic gage) | | |
| Drying vessel negative static | −11.6 | −2 |
| pressure during run (inches of WC) | | |
| Duration of run (min:sec) | 30:00 | 30:00 |

¹n/a = not applicable
²From Dwyer Instruments, “Dwyer Bulletin No. H-11” FR#440226 Rev. 8 (2005), available at http://www.dwyer-inst.com/htdocs/pdffiles/iom/airvelocity/160_iom.pdf (last visited, Feb. 14, 2007) → 2925 feet per minute (FPM) times 0.0123 sq. in. (for 1½″ diameter pipe) = 36 cubic feet per minute (CFM).

Results: Table 3 summarized the results of each thirty minute run;

TABLE 3
Experimental Run Results

| Factor | Run #1 | Run #2 |
|---|---|---|
| Material Wt. (oz.) @ Time 00:00 | 22¾ | 22⅞ |
| Material Wt. (oz.) @ Time 30:00 | 20¼ | 20¾ |
| Δ Material Wt. (oz.) | 2½ | 2⅛ |
| Δ H₂O content (%) | 14.08 | 11.72 |

Therefore, by modestly increasing the negative static pressure within the drying vessel namely, to −11.6″ WC from −2″ WC, the percentage of water removed increased by 20.1%. Also, the results confirm that by increasing the negative static pressure within the drying vessel the efficiency of drying improves, which will allow for substantially reduced (and therefore, improved) drying times.

While the present invention has been described with respect to what are some embodiments of the invention, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1) A process for drying a material comprising an intentionally controlled increased level of negative static pressure as compared to that which the process would inherently have when the negative static pressure is not intentionally controlled.

2) The process of claim 1, wherein as the intentionally controlled increased level of negative static pressure substantially increases removal of liquid from the material.

3) The process of claim 2, wherein the substantially increased removal of liquid from the material results in a substantially reduced drying time for the material.

4) The process of claim 1, further comprising a drying system which comprises at least one drying unit.

5) The process of claim 4, wherein the at least one drying unit is selected from the group consisting of a ploughshare dryer, conical dryer, indirect dryer, desiccant dryer, fluid bed dryer, blender dryer, helix dryer, mixer dryer, turbo dryer, air dryer, paddle dryer, belt dryer, filter press dryer, cone screw mixer dryer, and tri-shaft dryer.

6) The process of claim 5, wherein the at least one drying unit is a fluid bed dryer.

7) The process of claim 6, wherein the increased level of negative static pressure is less than about 124 inches of water column (527 mmHg).

8) The process of claim 6, wherein the increased level of negative static pressure is greater than that for atmospheric fluid bed drying.

9) The process of claim 6, wherein the increased level of negative static pressure is imparted in an area of the fluid bed dryer for drying the material.

10) The process of claim 1, wherein the material comprises a powder, a granulation, an agglomeration, pellets, or a mixture thereof.

11) The process of claim 1, wherein the material inherently is wet.

12) The process of claim 1, further comprising wetting the material.

13) A drying system comprising:
a) a preconditioning unit, which comprises a set of accessories including:
(i) at least one pre-filter; and
(ii) at least one bag filter;
wherein the set of accessories are in fluid communication with each other;
b) a negative static pressure control unit comprising:
(i) a static pressure control damper;
(ii) a static pressure sensor; and
(iii) a controller;
wherein the static pressure control damper, static pressure sensor and controller are in fluid communication with each other, and the negative static pressure control unit is in fluid communication with the preconditioning unit;
c) a dryer unit; and
d) an exhaust fan,
wherein the dryer unit is in fluid communication with the negative static pressure control unit and the exhaust fan.

14) The drying system of claim 13, wherein the set of accessories further comprises at least one face-and-bypass damper.

15) The drying system of claim 13, wherein the set of accessories further comprises at least one humidifier, at least one dehumidifier, or both.

16) The drying system of claim 13, wherein the set of accessories further comprises at least one cooling coil.

17) The drying system of claim 13, wherein the set of accessories further comprises at least one preheating coil, at least one freezing protection coil, or both

18) The drying system of claim 13, further comprising at least one final heating coil, at least one HEPA filter, at least one conditioning unit, at least one bypass damper, at least one vent cap, or a combination thereof.

19) The drying system of claim 13, wherein the dryer unit comprises at least one fluid bed dryer.

20) The drying system of claim 13, wherein the exhaust fan comprises a motor having an inverter disposed thereon, wherein the motor is in fluid communication with the exhaust fan.

21) The drying system of claim 13, wherein the exhaust fan comprises variable inlet vanes disposed on an inlet of the exhaust fan.

22) The drying system of claim 13, wherein the system operates under the process of claim 1.

23) A drying system for removing liquid from a material, comprising:
a) a preconditioning unit:
b) a negative static pressure control unit in fluid communication with the preconditioning unit;
c) a dryer unit; and
d) an exhaust fan;
wherein the dryer unit is in fluid communication with the negative static pressure control unit and the exhaust fan; and
wherein the negative static pressure control unit controls negative static pressure applied to the material so that as the negative static pressure increases in the system, the rate of liquid removed from the material increases.

24) The drying system of claim 24, wherein the material is dried at a substantially reduced drying time.
